(19) United States
(12) Patent Application Publication
(10) Pub. No.: US 2020/0099837 A1
(43) Pub. Date: Mar. 26, 2020

(54) IMAGE SENSOR RETAINING ELEMENT AND METHOD FOR MANUFACTURING AN IMAGE SENSOR RETAINING ELEMENT

(71) Applicant: Robert Bosch GmbH, Stuttgart (DE)

(72) Inventor: Peter Diesel, Bad Hindelang (DE)

(21) Appl. No.: 16/580,604

(22) Filed: Sep. 24, 2019

(30) Foreign Application Priority Data
Sep. 26, 2018 (DE) 102018216387.1

(51) Int. Cl. H04N 5/225; G02B 7/02; B60R 11/04

(52) U.S. Cl. CPC H04N 5/2254; G02B 7/025; G03B 17/12; G02B 7/022; B60R 11/04

(57) ABSTRACT

An image sensor retaining element for retaining an image sensor and a lens element is described. The image sensor retaining element initially includes a lens retaining element that is designed for accommodating the image sensor and/or an image sensor support. The image sensor retaining element also includes a lens support element (lens barrel) that is designed for accommodating at least one lens element, the lens support element (lens barrel) being situated in the lens retaining element. Lastly, the image sensor retaining element includes an adhesive that is situated between the lens retaining element and the lens support element (lens barrel) in the radial direction. The adhesive has an at least partially undulated contour on an outer circumference of the lens support element (lens barrel) and/or an inner circumference of the lens retaining element.

### CROSS REFERENCE

The present application claims the benefit under 35 U.S.C. § 119 of German Patent Application No. DE 102018216387.1 filed on Sep. 26, 2018, which is expressly incorporated herein by reference in its entirety.

### BACKGROUND INFORMATION

The present invention is directed to a device and a method. A further subject matter of the present invention relates to a computer program.

Adhesive materials that are curable with the aid of UV irradiation and/or by thermal means may be used to fixedly join together a camera lens or a lens element and an image sensor during an alignment of a camera unit. However, it is problematic that stresses occur due to different thermal expansions in the glued joining parts, or stress indices due to the curing characteristics of the adhesive; for an adhesion with long-term resistance, it is essential to reduce this stress in such a way that durability is provided under conditions of use.

### SUMMARY

An image sensor retaining element, a method for manufacturing an image sensor retaining element, a device that uses this method, and a corresponding computer program, are provided according to the present invention. Advantageous refinements and enhancements of the device according to the present invention are described herein.

In accordance with the present invention, an example image sensor retaining element is provided which establishes a connection between a lens retaining element for accommodating an image sensor, and a lens support element (as a lens barrel, for example) for accommodating a camera lens or a lens element, using an adhesive that is situated between the lens retaining element and the lens support element (lens barrel) in the radial direction, and that has an at least partially undulated contour.

An example image sensor retaining element in accordance with the present invention for retaining an image sensor and a lens element is provided, the image sensor retaining element having the following features:

a lens retaining element that is designed for accommodating the image sensor and/or an image sensor support;

a lens support element (as a lens barrel, for example) that is designed for accommodating at least one lens element, the lens support element (lens barrel) being situated in the lens retaining element; and

an adhesive that is situated between the lens retaining element and the lens support element (lens barrel) in the radial direction, the adhesive having an at least partially undulated shape on an outer circumference of the lens support element and/or an inner circumference of the lens retaining element.

An image sensor element may be, for example, a device for recording two-dimensional images of the surroundings from light in an electrical or mechanical manner. In most cases, semiconductor-based image sensors are used that are able to record light into the middle infrared. A lens element may be understood to mean, for example, a collecting optical system that forms the most important component of an imaging optical device, for example a camera unit. Thus, a lens element may generate a realistic optical image of an item, for example an object, a person, and/or an infrastructure feature, in the surroundings of a camera unit by guiding or directing light onto an image sensor of the camera unit. A lens retaining element may be, for example, a structure that is radially symmetrical on the inner side (interface to the lens barrel) and that may be situated on a circuit carrier (the interface to the image sensor is adapted to the image sensor support structure) in order to enclose a lens support element (lens barrel) for accommodating at least one lens element or being connected to same. The lens retaining element may, for example, also have a bearing function for supporting or for positioning a lens element. A lens support element may be, for example, a radially symmetrical structure that may be situated within a lens retaining element (the interface to the lens support element is likewise radially symmetrical) in order to accommodate a lens element and to protect the individual optical lenses and/or a lens system of the lens element from harmful external influences, or to correctly position it geometrically. The lens support element (lens barrel) may represent a connecting unit between the optical lens system of the lens element and a camera unit with an image sensor. An adhesive may be understood to mean, for example, a substance that is used for joining various components and/or materials with the aid of surface adhesion. In addition to the load-transmitting effect of the adhesive, further properties may be integrated into the components and/or materials to be joined, for example oscillation damping, sealing against liquids and gases, compensation for different joining part dynamics, corrosion protection, thermal and electrical insulation, or conductivity. In particular, the adhesive bond is used for tolerance and positioning compensation for the involved joining partners.

When an image sensor or the image sensor support or the lens retaining element is joined to a lens element with the aid of a radial adhesive contour, mechanical stresses are introduced into the adhesion due to occurring adhesive shrinkage as well as a difference in expansions of the lens support element (lens barrel) and of the lens retaining element. These stresses may be triggered and/or intensified by different types of influences, for example environmental conditions such as operating temperature range and moisture and/or mechanical loads and/or chemical influences, such as water and solvents, which externally act on the adhesion and cause the adhesive to shrink or swell. Thus, the process of UV precuring and thermal curing of an adhesive may result in adhesive shrinkage. For this reason, the adhesive should be able to absorb these stresses, since otherwise the adhesion and/or the glued joining partners, for example the lens support element (lens barrel) and the lens retaining element, could deform, as the result of which the functionality of a camera unit would be impaired, or the adhesion could fail, resulting in degradation or loss of the functionality of the connection.

Advantages of the example image sensor retaining element provided here include that, due to an undulated contour of an adhesive that is situated between a lens retaining element and a lens support element in the radial direction for joining an image sensor to a lens element, mechanical stress reduction is made possible despite external environmental effects, mechanical loads, and/or chemical influences. Adhesive shrinkage, swelling behavior of the adhesive, as well as a radial stress component that acts on the adhesive, the lens retaining element, and the lens support element may thus be reduced, as the result of which a possible deformation of the lens support element and of the lens retaining element may be counteracted via the design. Alternatively, these deformation areas could also be selected in a targeted manner. In addition, an optimal seal of the interface between the lens element and the image sensor may be achieved due to an undulated contour or an undulated shape of an adhesive that is situated between the lens retaining element and the lens support element in the radial direction.

According to one specific embodiment of the present invention, the lens retaining element (interface to the lens barrel) may be formed as a circumferential ring, the lens retaining element in particular having a radially symmetrical contour or shape (the shape is adapted to the lens barrel joining partner). One such specific embodiment of the approach presented here offers the advantage that the lens element or the lens support element (lens barrel) for accommodating the lens element likewise has a radially symmetrical shape, so that the lens support element together with the accommodated lens element may be connected and fixed in a form-fit manner to the lens retaining element (advantageously, however, with a provided adhesive gap, which may represent the tolerance compensation and the minimum adhesive gap) in order to produce an optimally operating camera unit in which the image sensor is optimally oriented with respect to the imaging plane of the lens.

According to another specific embodiment of the present invention, the adhesive may be continuously or circumferentially situated on an inner circumference of the lens retaining element, in particular the adhesive being formed as an adhesive bead. For example, an industrial robot with an adjusting arm, on which an adhesive nozzle and appropriate feed devices for the adhesive are provided, applies the adhesive continuously to the inner circumference of the lens retaining element (interface to the lens barrel). With the aid of the end-side adhesive nozzle, the adhesive in the form of the so-called adhesive bead may be applied to the workpieces, for example the lens retaining element and the lens support element (lens barrel), that are to be brought together and sealed off from one another. The adhesive bead may have, for example, a circular, triangular, quadrangular, oval, or star-shaped cross-sectional area. One such specific embodiment of the approach presented here thus offers the advantage that with the aid of a continuously applied adhesive bead, part tolerances, spaces, and/or gaps that occur between the lens retaining element and the lens support element (lens barrel) may be optimally bridged and/or sealed off.

In addition, according to one specific embodiment of the present invention, the lens retaining element may be glued and/or welded to an image sensor support for accommodating the image sensor. One such specific embodiment of the approach presented here offers the advantage that with the aid of an adhesive bond, the joining parts, i.e., the image sensor support and the lens retaining element, are not exposed to high temperatures. Thus, with the aid of an adhesive bond it is possible, for example, to join different materials together. An adhesive bond may at the same time act as a seal, and is often more cost-effective to implement than other joining methods. Different materials may also be joined together with the aid of a soldered joint. In addition, a soldered joint has a permanently tight connection. Furthermore, a soldered joint has good heat conductivity as well as good electrical conductivity.

According to one specific embodiment of the present invention, the lens retaining element may have a design that is (for example, radially) elastic or at least partially radially elastic, in particular when the lens retaining element includes protruding fingers. One such specific embodiment of the approach presented here offers the advantage that the stresses resulting from adhesive shrinkage and/or swelling behavior of the adhesive may be absorbed by the radially elastic design of the lens retaining element, and thus partially compensated for or reduced. Thus, an elastic effect of the protruding fingers of the lens retaining element may advantageously also be utilized for further stress reduction.

According to another specific embodiment of the present invention, the adhesive may contact a (for example, radially) elastic portion of the lens retaining element, in particular one of the protruding fingers of the lens retaining element of the lens support element (lens barrel). One such specific embodiment of the approach presented here offers the advantage that by contacting the adhesive on the protruding fingers of the lens retaining element, interlocking or intermeshing of both components is possible, so that the lens retaining element may be connected to the lens support element (lens barrel) in a form-fit manner in order to produce an optimally operating camera unit.

In addition, according to one specific embodiment of the present invention, the adhesive may be situated on an outer contour of the one (for example, radially) elastic portion of the lens retaining element, in particular the finger of the lens retaining element, in particular the shape of the one elastic portion of the lens retaining element or of the fingers of the lens retaining element corresponding to the undulated shape or undulated contour of the adhesive. The shape of the fingers and/or an undulated contour of the adhesive may be compressed, for example, to achieve a more finger-like design. One such specific embodiment of the approach presented here offers the advantage that by compressing the shape of the fingers and/or the undulated contour of the adhesive, an enlarged joining surface between the lens retaining element and the lens support element may be achieved, a distribution of the stress on this enlarged joining surface allowing a reduced mechanical load on the lens retaining element and the lens support element (lens barrel). The enlargement of the adhesive bond surface reduces the surface tension in the contact area. Residual stresses, which may be introduced into the interfaces between the joining partners and/or the joining partners themselves, for example due to curing of the adhesive and external environmental conditions, the shape of the fingers and/or of the undulated contour, may be distributed over a greatly enlarged surface, depending on the compression.

In addition, by compressing the shape of the fingers and/or the undulated contour of the adhesive, improved exposure conditions may advantageously be achieved, since an extended light-accessible contour boundary has been created. In contrast to an adhesive having a strictly radial design between the lens retaining element and the lens support element, the undulated contour for curing the adhesive with the aid of UV irradiation is not just achievable axially. This results in tangential exposure options that may greatly increase the length of the connection. Thus, adhesive shrinkage that may be caused, for example, by UV precuring and thermal curing and/or swelling of the adhesive due to temperature and moisture influences, may thus take place locally on two axes in radial and tangential directions.

An example camera unit for detecting the surroundings is provided according to the present invention, the camera unit including an image sensor, a lens element, and the image sensor retaining element. A camera unit may be, for example, a photographic apparatus that electronically records static or moving images on a magnetic videotape or digital memory medium, or that may transmit via an interface. The camera unit may be, for example, a digital vehicle camera that is, for example, situated on a vehicle and is also designed to continuously detect, depict, or to further process pieces of image information or images of the persons, objects, and/or infrastructure features situated there. Alternatively, the camera unit may be a monitoring camera that is used to observe one or multiple monitoring areas. Thus, for example, a conspicuous object situated in the monitoring area, for example a person or a vehicle, may be tracked by the monitoring camera.

In accordance with the present invention, a method for manufacturing an image sensor element is provided, the method including the following steps:

Providing a lens retaining element and a lens support element (as a lens barrel or lens, for example);

Applying an adhesive having an at least partially undulated shape or having an undulated contour to an outer circumference of the lens support element (lens barrel) and/or to an inner circumference of the lens retaining element, in particular in the area of the interface of the lens retaining element and the lens support element (lens barrel); and

Connecting the lens retaining element to the lens support element (lens barrel), an outer radius of a radial contour of the lens support element (lens barrel) being smaller than an inner radius of the contour of the lens retaining element, so that the adhesive is situated between an outer side of the lens support element and an inner side of the lens retaining element in the radial direction, in order to manufacture the image sensor retaining element.

According to one specific embodiment of the present invention, the step of providing, the step of applying, and/or the step of connecting may be carried out repeatedly; in a repeatedly carried out step of applying, the adhesive is applied in a different undulated contour than in a preceding step of applying. One such specific embodiment of the approach presented here offers the advantage that the shape and geometry of the undulated contour of the adhesive are selectable on a production-specific basis, thus ensuring a high degree of flexibility.

According to another specific embodiment of the present invention, the method may include a step of curing, in which the adhesive is partially or completely cured thermally, electrically, chemically, and/or with the aid of light, in particular UV light and/or laser light. One such specific embodiment of the approach presented here offers the advantage that adhesive that polymerizes with the aid of irradiation with specialized UV light sources and thus cures may be used in particular in the industrial sector, since it cures within seconds and thus allows manufacture in facilities with high cycle times. Adhesive that thermally cures at room temperature or with heating may likewise be used in particular in the industrial sector, in particular when the joining partners to be adhered, for example a lens retaining element and a lens support element, are not heat-sensitive or transparent, and the adhesive thus cannot be cured with the aid of light or UV light. The adhesive may, for example, also have a dual curing design, an initial strength of the adhesive being achieved with the aid of irradiation with light or UV light, and shadow zones and/or deeper adhesive layers lastly being thermally post-cured under the effect of heat.

For adhesive that is electrically cured, the advantage results, for example, that the adhesive has a lower viscosity, so that surfaces may be very well coated and joining partners may be precisely brought into position in a very satisfactory manner before the adhesion is set. This approach is thus suited in particular for use during an alignment of a camera unit. The resulting adhesive bonds remain flexible and may withstand high shear forces.

Alternatively, the adhesive may also be cured with the aid of chemical reaction processes.

The example method(s) provided here for manufacturing an image sensor retaining element may be implemented, for example, in a control unit, for example in software or hardware or in a mixed form of software and hardware.

The approach presented here also provides a device that is designed for carrying out, controlling, or implementing the steps of a variant of a method presented here for manufacturing an image sensor retaining element in appropriate equipment. The object underlying the approach may also be quickly and efficiently achieved by this embodiment variant of the present invention in the form of a device.

For this purpose, the example device may include at least one processing unit for processing signals or data, at least one memory unit for storing signals or data, at least one interface to a sensor or an actuator for reading in sensor signals from the sensor or for outputting data and control signals to the actuator, and/or at least one communication interface for reading in or outputting data that are embedded in a communication protocol. The processing unit may be, for example, a signal processor, a microcontroller, or the like, and the memory unit may be a flash memory, an EEPROM, or a magnetic memory unit. The communication interface may be designed for reading in or outputting data wirelessly and/or in a line-bound manner; a communication interface which may read in or output the line-bound data may read in these data electrically or optically, for example, from an appropriate data transmission line, or output same to an appropriate data transmission line.

In the present context, a device may be understood to mean an electrical device that processes sensor signals and outputs control and/or data signals as a function thereof. The device may include an interface which may have a hardware and/or software design. In a hardware design, the interfaces may be part of a so-called system ASIC, for example, which contains various functions of the device. However, it is also possible for the interfaces to be dedicated, integrated circuits, or to be at least partially made up of discrete components. In a software design, the interfaces may be software modules which are present on a microcontroller, for example, in addition to other software modules.

Also advantageous is a computer program product or a computer program including program code which may be stored on a machine-readable medium or memory medium such as a semiconductor memory, a hard disk, or an optical memory, and used for carrying out, implementing, and/or controlling the steps of the method according to one of the specific embodiments described above, in particular when the program product or program is executed on a computer or a device.

Exemplary embodiments of the present invention presented here are illustrated in the figures and are explained in greater detail below.

### BRIEF DESCRIPTION OF THE DRAWINGS

FIG. 1 shows a schematic view of a camera unit for detecting the surroundings according to one exemplary embodiment.

FIG. 2 shows a schematic longitudinal sectional view of an image sensor retaining element for retaining an image sensor or an image sensor support and a lens element according to one exemplary embodiment, radial gluing with a non-undulated adhesive contour being depicted.

FIG. 3 shows a schematic longitudinal sectional view of an image sensor retaining element for retaining an image sensor or an image sensor support and a lens element according to one exemplary embodiment, axial gluing being illustrated.

FIG. 4 shows a schematic view of a connecting area between a lens support element and a lens retaining element according to one exemplary embodiment, a non-undulated adhesive arrangement being illustrated.

FIG. 5 shows a schematic longitudinal sectional view of an image sensor retaining element for retaining an image sensor or an image sensor support and a lens element according to one exemplary embodiment, an undulated adhesive contour being illustrated.

FIG. 6 shows a schematic view of a connecting area between a lens support element and a lens retaining element according to one exemplary embodiment, an undulated adhesive contour being illustrated.

FIG. 7 shows a block diagram of a device for manufacturing an image sensor retaining element according to one exemplary embodiment.

FIG. 8 shows a flow chart of one exemplary embodiment of a method for manufacturing an image sensor retaining element according to one exemplary embodiment.

In the following description of advantageous exemplary embodiments of the present invention, identical or similar reference numerals are used for the elements having a similar action which are illustrated in the various figures, and a repeated description of these elements is dispensed with.

### DETAILED DESCRIPTION OF EXAMPLE EMBODIMENTS

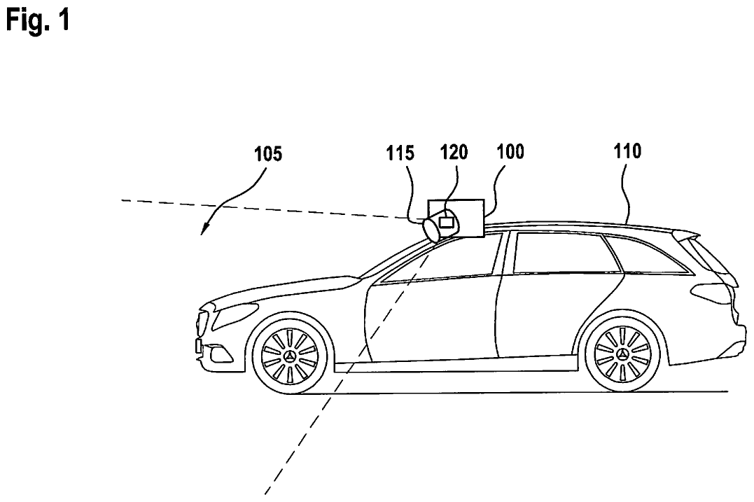

FIG. 1 shows a schematic view of a camera unit 100 for detecting the surroundings 105 in the detection range of the camera unit according to one exemplary embodiment. According to one exemplary embodiment, camera unit 100 is situated on a vehicle 110, and by way of example includes a lens element 115 and an image sensor 120.

Camera unit 100 illustrated here is thus used, for example, as part of a driving assistance system for detecting the surroundings of vehicle 110. For example, persons, objects, and/or infrastructure features may be situated in the surroundings 105 of vehicle 110 and may be detected and depicted with the aid of camera unit 100, for example, in order to avoid possible accidents and ensure safe driving of vehicle 110. Accordingly, for camera unit 100 the aim is to implement designs with an approximately cubic configuration and edge lengths smaller than 25 mm. This applies in particular for NRCS systems, but not for front video systems installed in the passenger compartment. Alternatively, camera unit 100 may also be used as a monitoring camera unit for observing one or multiple monitoring areas. A conspicuous object situated in the monitoring area, for example a person or a vehicle, may thus be tracked by the monitoring camera.

The optical modules of camera unit 100 are typically manufactured with the aid of so-called active alignment processes. In the process, an alignment of lens element 115 with image sensor 120, or of image sensor 120 with lens element 115, is carried out based on the sensor chip of camera unit 100, using a plurality of repeatedly recorded video data, in order to achieve the best position for achieving the correct focusing and the viewing direction axis of camera unit 100.

In an active alignment of camera unit 100, in addition the image focusing cap of a lens system, i.e., lens element 115, may be brought into the image sensor plane and fixed in this position with the aid of mechanical multiaxial correction. The alignment correction is actively checked with the aid of signal evaluation of the light-sensitive sensor plane. The method corrects lens tolerances, alignment errors, and/or alignment deviations, as well as the focus position, that result due to component tolerances and their tolerance chains in the assembly process. This process requires complicated mechanical correction systems and is time-intensive, since the sensor signals must be evaluated for correction control.

In a passive alignment of a camera unit 100, positioning of lens element 115 takes place based on mechanical features that are positioned with respect to one another without actively operating image sensor 120. However, it is not possible to compensate for the tolerances of the various mechanical features.

A procedure for manufacturing a camera unit 100 is gluing the outer contour, which in a first approximation is cylindrical or radially symmetrical, of a lens support element (lens barrel) for accommodating a lens element 115, to the contour, which at the interface likewise has a cylindrical or radially symmetrical contour, of a lens retaining element for accommodating an image sensor 120. The lens retaining element thus implements a component-appropriate connection to the likewise cylindrical lens support element (lens barrel), and a component-appropriate connection to the image sensor support (i.e., the interface is driven by the sensor support), which is flat, rectangular, or square and is situated in a plane perpendicular to the optical axis of the lens support element or of lens element 115. The connection of the lens support element (lens barrel) to the lens retaining element, with the lens support element (lens barrel) situated in the lens retaining element, takes place with the aid of radial gluing or with the aid of axial gluing.

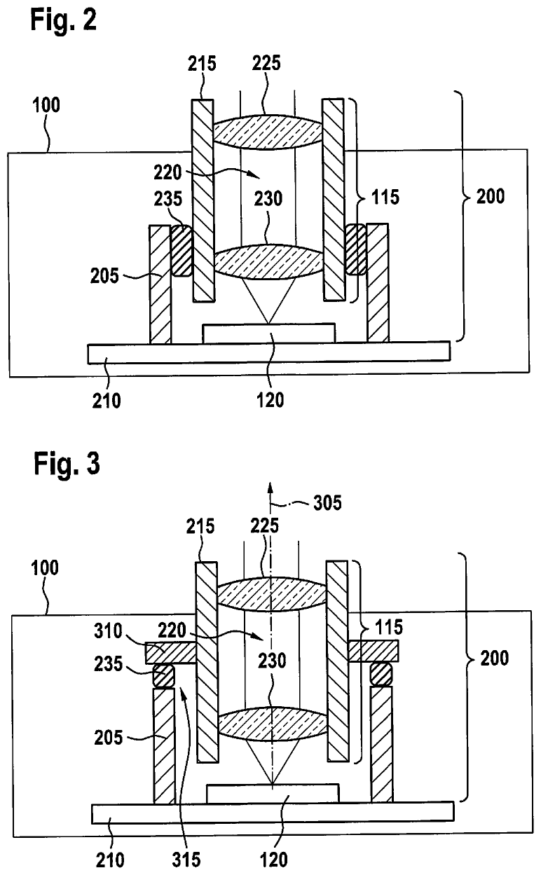

FIG. 2 shows a schematic longitudinal sectional view of an image sensor retaining element 200 for retaining an image sensor 120 and a lens element 115 according to one exemplary embodiment.

According to one exemplary embodiment, image sensor retaining element 200 is situated in a camera unit 100 for detecting the surroundings. Thus, image sensor retaining element 200 includes by way of example a lens retaining element 205, lens retaining element 205 being designed for accommodating image sensor 120 and/or an image sensor support 210. Image sensor 120 and lens retaining element 205 are situated, for example, on image sensor support 210, image sensor 120 and lens retaining element 205 being glued and/or welded to image sensor support 210. Image sensor retaining element 200 also includes a lens support element (lens barrel) 215 that is designed to accommodate lens element 115. In this case, lens element 115 is designed to guide incident light 220 onto image sensor 120, and includes optical lenses 225 and 230 by way of example (in reality, the lens systems are in various configurations) which image the surroundings on the sensor.

Lens support element (lens barrel) 215 and lens retaining element 205 are each designed as a cylinder, for example (in reality, radially symmetrical lens barrels, and thus, also radially symmetrical lens retaining elements at this interface, are preferred for manufacturing reasons). According to one exemplary embodiment, lens support element 215 is situated in lens retaining element 205, the radius of lens support element 215 being smaller than the radius of lens retaining element 205, so that lens support element 215 is introducible into lens retaining element 205. According to one exemplary embodiment, lens support element 215 and lens retaining element 205 are connected in a form-fit manner, which is not explicitly illustrated in FIG. 2.

Lastly, image sensor retaining element 200 includes an adhesive 235 that is situated between lens retaining element 205 and lens support element 215 in the radial direction in order to connect these two components in a form-fit manner, adhesive 235 being situated on an outer circumference of lens support element 215 and/or an inner circumference of lens retaining element 205. The end result is a form-fit connection. However, the adhesive is used in particular to close the intended “clearance fit,” which represents the tolerance compensation and the minimum adhesive layer thickness.

FIG. 3 shows a schematic longitudinal sectional view of an image sensor retaining element 200 for retaining an image sensor 120 and a lens element 115 according to one exemplary embodiment.

According to one exemplary embodiment, image sensor retaining element 200 is situated in a camera unit 100 for detecting the surroundings. Thus, image sensor retaining element 200 includes by way of example a lens retaining element 205, lens retaining element 205 being designed for accommodating image sensor 120. Image sensor 120 and lens retaining element 205 are situated, for example, on an image sensor support 210, image sensor 120 and lens retaining element 205 being glued and/or welded to image sensor support 210. Image sensor retaining element 200 also includes a lens support element (lens barrel) 215 that is designed to accommodate lens element 115. In this case, lens element 115 is designed to guide light 220 onto image sensor 120, and includes two optical lenses 225 and 230 by way of example which correct possible perspective errors in the imaging of the surroundings of camera unit 100.

Lens support element 215 and lens retaining element 205 are each designed as a circular cylinder, for example. According to one exemplary embodiment, lens support element 215 is situated in lens retaining element 205, a radius of lens support element 215 being smaller than a radius of lens retaining element 205, so that lens support element 215 is introducible into lens retaining element 205. According to one exemplary embodiment, lens support element 215 and the lens retaining element are connected in a form-fit manner. In contrast to image sensor retaining element 200 shown in FIG. 2, lens support element 215 includes a circular ring 310 that is oriented radially with respect to lens element longitudinal axis 305, circular ring 310 continuously enclosing cylindrical lens support element 215. A surface of circular ring 310 completely covers lens retaining element 205, a gap 315 being formed between circular ring 310 and lens retaining element 205. Such a shape corresponds to axial gluing.

Lastly, image sensor retaining element 200 includes an adhesive 235 that is situated in gap 315 between an end of lens retaining element 205 facing away from image sensor support 210 and a side of circular ring 310 of lens support element 215 facing image sensor support 210 in the axial direction, in order to connect these two components.

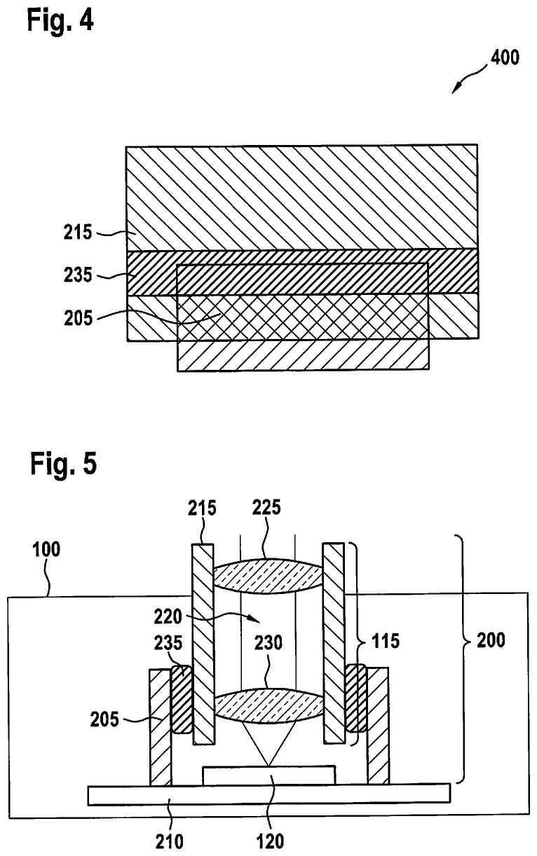

FIG. 4 shows a schematic view of the development of the interface of the radial interface area of the adhesion of a connecting area 400 between a lens support element 215 and a lens retaining element 205 according to one exemplary embodiment. In the schematic view of connecting area 400, this is a detailed view of connecting area 400, with only lens support element 215, lens retaining element 205, and adhesive 235 illustrated. Lens retaining element 205 is illustrated as semi-transparent by way of example. The figure is used to illustrate the non-undulated radial gluing in the interface.

A radius of cylindrical lens support element 215 is smaller than a radius of likewise cylindrical lens retaining element 205, so that lens support element 215 is situatable in lens retaining element 205. According to one exemplary embodiment, lens retaining element 205 is connected to lens support element 215 with the aid of adhesive 235, adhesive 235 being situated between an outer side of lens support element 215 and an inner side of lens retaining element 205 in the radial direction. Adhesive 235 by way of example is arranged continuously on an inner circumference of lens retaining element 205, and is formed as an adhesive bead. According to one exemplary embodiment, the adhesive bead has a quadrangular cross-sectional shape (in the end result, the contour always results from the geometric arrangement of the position-aligned joining partners, and the adhesive “fills” only this gap), particularly effective bridging and sealing of gaps between lens support element 215 and lens retaining element 205 in the millimeter range being possible due to this formation. To fix the connection between lens support element 215 and lens retaining element 205, adhesive 235 is subsequently curable thermally, electrically, or chemically and/or with the aid of light, or is curable in some other way.

FIG. 5 shows a schematic longitudinal sectional view of an image sensor retaining element 200 for retaining an image sensor 120 and a lens element 115 according to one exemplary embodiment, with an undulated adhesive contour. Reference is made once again to the above statements with regard to the undulated adhesive contour.

According to one exemplary embodiment, image sensor retaining element 200 is situated in a camera unit 100 for detecting the surroundings. Thus, image sensor retaining element 200 includes by way of example a lens retaining element 205, lens retaining element 205 being designed for accommodating image sensor 120. Image sensor 120 and lens retaining element 205 are situated, for example, on an image sensor support 210, image sensor 120 and lens retaining element 205 being glued and/or welded to image sensor support 210. Image sensor retaining element 200 also includes a lens support element 215 that is designed to accommodate lens element 115. In this case, lens element 115 is designed to guide light 220 onto image sensor 120, and includes two optical lenses 225 and 230 by way of example which correct possible perspective errors in the imaging of the surroundings of camera unit 100.

Lens support element 215 and lens retaining element 205 are each designed as a circular cylinder, for example. According to one exemplary embodiment, lens support element 215 is situated in lens retaining element 205, a radius of lens support element 215 being smaller than a radius of lens retaining element 205, so that lens support element 215 is introducible into lens retaining element 205. According to one exemplary embodiment, lens support element 215 and the lens retaining element are connected in a form-fit manner.

Lastly, image sensor retaining element 200 includes an adhesive 235 that is situated between lens retaining element 205 and lens support element 215 in the radial direction in order to connect these two components in a form-fit manner. Adhesive 235 has an at least partially undulated contour on an outer circumference of lens support element 215 and/or an inner circumference of lens retaining element 205. Thus, it is clear in the illustration that with the aid of the undulated contour of adhesive 235, an enlarged joining surface between lens retaining element 205 and lens support element 215 is provided, a distribution of mechanical stress on this enlarged joining surface allowing a reduced mechanical load on lens retaining element 205 and lens support element 215.

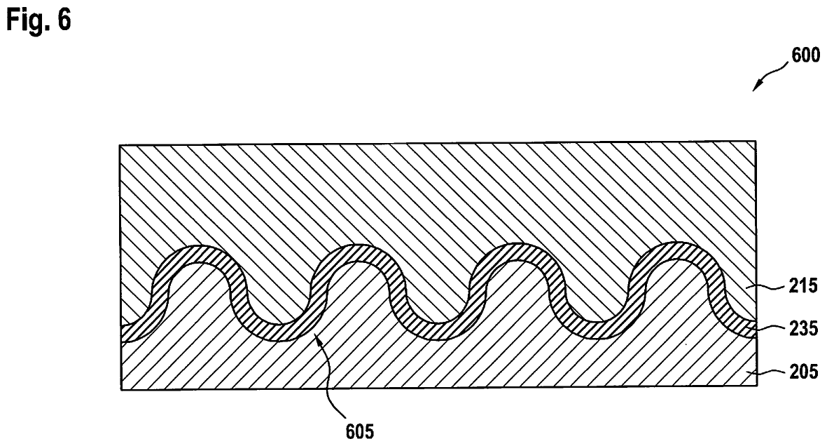

FIG. 6 shows a schematic view of a connecting area 600 between a lens support element 215 and a lens retaining element 205 according to one exemplary embodiment, with an undulated adhesive contour. In the schematic view of connecting area 600, this is a detailed view of connecting area 600, with only lens support element 215, lens retaining element 205, and adhesive 235 illustrated. Lens retaining element 205 is illustrated as semi-transparent by way of example. The statements with regard to FIG. 4 likewise apply to the exemplary embodiment illustrated in FIG. 6.

A radius of cylindrical lens support element 215 is smaller than a radius of likewise cylindrical lens retaining element 205, so that lens support element 215 is situatable in lens retaining element 205. According to one exemplary embodiment, lens retaining element 205 is connected to lens support element 215 with the aid of adhesive 235, adhesive 235 being situated between lens support element 215 and lens retaining element 205 in the radial direction. Adhesive 235 also has, for example, an undulated contour on an outer circumference of lens support element 215 and/or an inner circumference of lens retaining element 205. The undulated contour of adhesive 235 has a semicircular design, for example. Adhesive 235 is arranged continuously on an inner circumference of lens retaining element 205, and is formed as an adhesive bead. To fix the connection between lens support element 215 and lens retaining element 205, adhesive 235 is subsequently curable thermally, electrically, or chemically and/or with the aid of light.

According to one exemplary embodiment, lens retaining element 205 has an elastic design and includes a plurality of protruding fingers 605. Adhesive 235 contacts protruding fingers 605 of lens retaining element 205, adhesive 235 being situated on an outer contour of fingers 605 of lens retaining element 205. The shape of fingers 605 of lens retaining element 205 advantageously corresponds to that of the undulated contour of adhesive 235, fingers 605 of lens retaining element 205 as well as the undulated contour of adhesive 235 having a semicircular design and thus optimally intermeshing and/or interlocking. Alternatively, the shape of fingers 605 of lens retaining element 205 and the undulated contour of adhesive 235 may have a compressed design so that a finger-like formation of fingers 605 of adhesive 235 is achieved, as the result of which an enlarged joining surface between lens retaining element 205 and lens support element 215 may be achieved. By compressing the shape of fingers 605 and/or the undulated contour of adhesive 235, an extended light-accessible contour boundary of adhesive 235 is likewise achievable, as the result of which improved exposure conditions of adhesive 235 may be achieved.

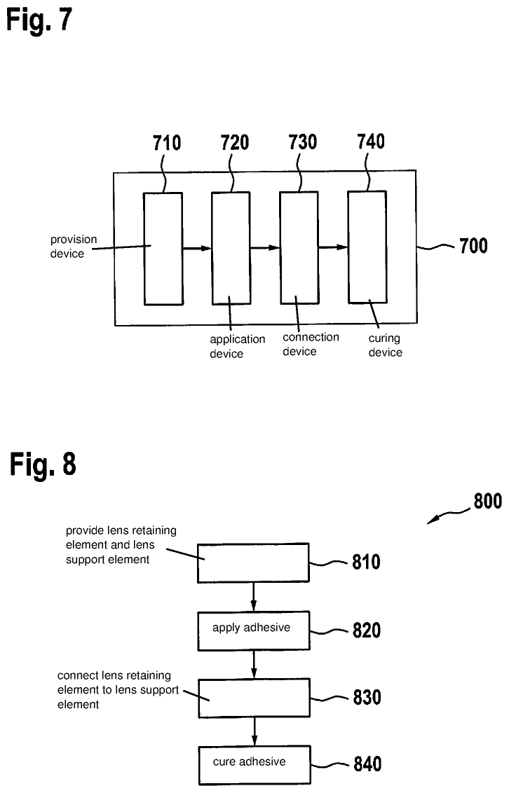

FIG. 7 shows a block diagram of a device 700 for manufacturing an image sensor retaining element according to one exemplary embodiment. According to one exemplary embodiment, device 700 includes a provision device 710, an application device 720, a connection device 730, and a curing device 740.

Provision device 710 is designed, for example, to provide a lens retaining element and a lens support element. Application device 720 which follows is designed to apply an at least partially undulated adhesive to an outer circumference of the lens support element and/or to an inner circumference of the lens retaining element. Connection device 730 is designed to connect the lens retaining element to the lens support element, a radius of the lens support element being smaller than a radius of the lens retaining element, so that the adhesive is situated between an outer side of the lens support element and an inner side of the lens retaining element in the radial direction in order to manufacture the image sensor retaining element. Lastly, curing device 740 is designed to cure the adhesive thermally, electrically, or with the aid of light, in particular UV light and/or laser light, in order to fix the connection between the lens retaining element and the lens support element.

FIG. 8 shows a flow chart of one exemplary embodiment of a method 800 for manufacturing an image sensor retaining element according to one exemplary embodiment. According to one exemplary embodiment, method 800 may be carried out on the device for manufacturing an image sensor retaining element from FIG. 7.

Method 800 initially includes a step 810 in which a lens retaining element and a lens support element are provided. An adhesive having an at least partially undulated shape is applied to an outer circumference of the lens support element and/or to an inner circumference of the lens retaining element in a subsequent step 820 of method 800. Lastly, the lens retaining element is connected to the lens support element in a step 830 of method 800, a radius of the lens support element being smaller than a radius of the lens retaining element, so that the adhesive is situated between an outer side of the lens support element and an inner side of the lens retaining element in the radial direction in order to manufacture the image sensor retaining element. The adhesive is cured thermally, electrically, or with the aid of light, in particular UV light and/or laser light, in a final step 840 of method 800 in order to fix the connection between the lens retaining element and the lens support element.

If an exemplary embodiment includes an “and/or” linkage between a first feature and a second feature, this is to be understood in such a way that according to one specific embodiment, the exemplary embodiment has the first feature as well as the second feature, and according to another specific embodiment, the exemplary embodiment either has only the first feature or only the second feature.

What is claimed is:

1. An image sensor retaining element for retaining an image sensor and a lens element, the image sensor retaining element comprising:
a lens retaining element configured to accommodate the image sensor and/or an image sensor support;
a lens support element configured to accommodate at least one lens element, the lens support element being situated in the lens retaining element; and
an adhesive situated between the lens retaining element and the lens support element in a radial direction, the adhesive having an at least partially undulated shape on: (i) an outer circumference of the lens support element, and/or (ii) an inner circumference of the lens retaining element.

2. The image sensor retaining element as recited in claim 1, wherein the lens retaining element is a circumferential ring, the lens retaining element having a radially symmetrical shape at an interface to the lens support element.

3. The image sensor retaining element as recited in claim 2, wherein the adhesive is continuously or circumferentially situated on an inner circumference of the lens retaining element, the adhesive being formed as an adhesive bead.

4. The image sensor retaining element as recited in claim 1, wherein the lens retaining element is glued and/or welded and/or mechanically fastened, to the image sensor support for accommodating the image sensor.

5. The image sensor retaining element as recited in claim 1, wherein the lens retaining element has an at least partially elastic configuration.

6. The image sensor retaining element as recited in claim 1, wherein the lens retaining element has a radially elastic design.

7. The image sensor retaining element as recited in claim 1, wherein the lens retaining element includes protruding fingers.

8. The image sensor retaining element as recited in claim 5, wherein the adhesive contacts an elastic portion of the lens retaining element.

9. The image sensor retaining element as recited in claim 6, wherein the adhesive contacts a radially elastic portion of the lens retaining element.

10. The image sensor retaining element as recited in claim 7, wherein one of the protruding fingers of the lens retaining element contacts the lens retaining element.

11. The image sensor retaining element as recited in claim 7, wherein the adhesive is situated on an outer contour of the fingers of the lens retaining element, a shape of the fingers of the lens retaining element being adapted to the undulated shape of the adhesive.

12. A camera unit detecting surroundings, comprising:
an image sensor;
a lens element; and
an image sensor retaining element including a lens retaining element configured to accommodate the image sensor and/or an image sensor support, a lens support element configured to accommodate the lens element, the lens support element being situated in the lens retaining element, and an adhesive situated between the lens retaining element and the lens support element in a radial direction, the adhesive having an at least partially undulated shape on: (i) an outer circumference of the lens support element, and/or (ii) an inner circumference of the lens retaining element.

13. A method for manufacturing an image sensor retaining element, the method comprising the following steps:
providing a lens retaining element and a lens support element;
applying an adhesive having an at least partially undulated shape to: (i) an outer circumference of the lens support element, and/or (ii) to an inner circumference of the lens retaining element; and
connecting the lens retaining element to the lens support element, a radius of the lens support element being smaller than a radius of the lens retaining element, so that the adhesive is situated between an outer side of the lens support element and an inner side of the lens retaining element in a radial direction.

14. The method as recited in claim 13, wherein the providing step, and/or the applying step, and/or the connecting step, is carried out repeatedly.

15. The method as recited in claim 13, wherein the applying step is repeatedly carried out, the adhesive being applied in a different undulated contour than in a preceding step of applying.

16. The method as recited in claim 13, further comprising the following step:
curing the adhesive thermally, and/or electrically, and/or chemically, and/or with the aid of light.

17. The method as recited in claim 13, further comprising the following step:
curing the adhesive using UV light and/or laser light.

18. A device for manufacturing an image sensor retaining element, the device configured to:
provide a lens retaining element and a lens support element;
apply an adhesive having an at least partially undulated shape to: (i) an outer circumference of the lens support element, and/or (ii) to an inner circumference of the lens retaining element; and
connect the lens retaining element to the lens support element, a radius of the lens support element being smaller than a radius of the lens retaining element, so that the adhesive is situated between an outer side of the lens support element and an inner side of the lens retaining element in a radial direction.

19. A non-transitory machine-readable memory medium on which is stored a computer program for manufacturing an image sensor retaining element, the computer program, when executed by a computer, causing the computer to perform:
providing a lens retaining element and a lens support element;
applying an adhesive having an at least partially undulated shape to: (i) an outer circumference of the lens support element, and/or (ii) to an inner circumference of the lens retaining element; and
connecting the lens retaining element to the lens support element, a radius of the lens support element being smaller than a radius of the lens retaining element, so that the adhesive is situated between an outer side of the lens support element and an inner side of the lens retaining element in a radial direction.
